(19) United States
(12) Patent Application Publication
(10) Pub. No.: US 2023/0229102 A1
(43) Pub. Date: Jul. 20, 2023

(54) IMAGE FORMING APPARATUS

(71) Applicant: CANON KABUSHIKI KAISHA, Tokyo (JP)

(72) Inventors: YUSUKE YAMAGUCHI, Chiba (JP); HIROKI KAWAI, Chiba (JP); ASUNA FUKAMACHI, Chiba (JP)

(21) Appl. No.: 18/150,734

(22) Filed: Jan. 5, 2023

(30) Foreign Application Priority Data
Jan. 19, 2022 (JP) 2022-006620

(51) Int. Cl. G03G 15/20

(52) U.S. Cl. CPC G03G 15/205; G03G 15/2064; G03G 2215/2038

(57) ABSTRACT

An image forming apparatus is disclosed. A fixing device includes a heating rotary member and a pressing rotary member. The fixing device further includes an acquisition means that acquires information about a printing medium for a predetermined number of sheets beforehand, and a temperature control means that controls a temperature of the heating rotary member based on the information about a basis weight acquired by the acquisition means. A job in which different basis weights are mixed is a mixed job. In a case where the mixed job is executed and the temperature of the heating rotary member is changed while the mixed job is executed, a change amount of the temperature of the heating rotary member is reduced based on the information about the basis weight of the printing medium acquired by the acquisition means.

### BACKGROUND OF THE INVENTION

### Field of the Invention

The present invention relates to a fixing device that fixes a toner image on a printing medium.

### Description of the Related Art

An image forming apparatus includes a fixing device that fixes an unfixed toner image formed on a printing medium to the printing medium.

As a configuration of a fixing device, there is known a configuration that includes a heating rotary member including a heat source for heating an unfixed toner image, and a pressing rotary member that presses the heating rotary member (Japanese Patent Application Laid-Open No. 2011-242598). The fixing device further includes a contact separation mechanism, and the contact separation mechanism can move the pressing rotary member between a position in contact with the heating rotary member and a position away from the heating rotary member. In a case where the pressing rotary member is at the position in contact with the heating rotary member, a nip portion is formed by the heating rotary member and the pressing rotary member. When a printing medium carrying an unfixed toner image is conveyed to the nip portion, heat and pressure required for fixing are applied at the nip portion, and toner on the printing medium is fixed.

In a case where a toner image is formed on a printing medium, an amount of heat required for fixing of the toner image varies depending on the type of printing medium. Japanese Patent Application Laid-Open No. 2011-242598 discusses a technique of changing the temperature of the heating rotary member depending on the type of printing medium. The amount of heat to be applied to the toner image on the printing medium is thereby appropriately controlled.

When the amount of heat is changed depending on the type of printing medium, image quality of the toner image formed on the printing medium improves. However, in a case where the temperature is changed for every printing medium, productivity decreases. Thus, in a fixing device having an image-quality priority mode and a productivity priority mode, a user can select a mode to use for fixing depending on the intended use.

In Japanese Patent Application Laid-Open No. 2011-242598, in the fixing device having a plurality of modes, the temperature of the heating rotary member is changed depending on the type of printing medium for which fixing is to be performed.

However, in a case where fixing is performed for a job in which printing media varying in basis weight are mixed, the temperature of the heating rotary member is to be changed each time the type of printing medium changes, and therefore, a reduction in productivity can occur.

### SUMMARY OF THE INVENTION

The present invention is directed to a fixing device that prevents a reduction in productivity in a case where fixing is performed for a job in which printing media varying in type are mixed.

According to an aspect of the present invention, an image forming apparatus includes a heating rotary member configured to apply heat to a printing medium, a pressing rotary member configured to press the heating rotary member, an acquisition means configured to acquire information about a basis weight of a printing medium for which fixing is to be performed, and a temperature control means configured to control a fixing temperature based on the information acquired by the acquisition means, wherein the heating rotary member and the pressing rotary member apply heat and pressure to a printing medium to fix a toner image on the printing medium, wherein, for a mixed job in which a printing medium of a first basis weight is a first sheet and a printing medium of a second basis weight different from the first basis weight is a second sheet, one mode among a plurality of modes including a first mode and a second mode is executable in the mixed job, wherein, in a case where the mixed job is performed in the first mode, the temperature control means controls the fixing temperature for the printing medium of the first basis weight based on the information about the printing medium of the first basis weight and the printing medium of the second basis weight, and wherein, in a case where fixing is performed for the mixed job in the second mode, the temperature control means controls the fixing temperature for the printing medium of the first basis weight based on the information about the printing medium of the first basis weight.

Further features of the present invention will become apparent from the following description of exemplary embodiments with reference to the attached drawings.

### BRIEF DESCRIPTION OF THE DRAWINGS

FIG. 1 is a schematic diagram of a cross section of an image forming apparatus according to an exemplary embodiment.

FIG. 2 is a schematic diagram of a cross section of a fixing device according to the exemplary embodiment.

FIG. 3 is a diagram illustrating a heat distribution of a halogen heater according to the exemplary embodiment.

FIG. 4 is a block diagram according to the exemplary embodiment.

FIGS. 5A, 5B, 5C, and 5D are diagrams each illustrating a temperature table depending on a mode according to the exemplary embodiment.

FIG. 6 is a flowchart illustrating processing for automatically setting a mode according to the exemplary embodiment.

FIG. 7 is a diagram illustrating an effect of the present exemplary embodiment in a first detailed verification.

FIG. 8 is a diagram illustrating an effect of the present exemplary embodiment in a second detailed verification.

FIG. 9 is a flowchart illustrating processing for performing a third detailed verification.

FIGS. 10A and 10B are diagrams each illustrating a temperature of a heating rotary member in the third detailed verification.

FIG. 11 is a diagram illustrating an effect of the present exemplary embodiment in the third detailed verification.

### DESCRIPTION OF THE EMBODIMENTS

An exemplary embodiment of an image forming apparatus will be described below with reference to the drawings. An example in which the exemplary embodiment is applied to an electrophotographic full-color image forming apparatus including a plurality of photosensitive drums will be described below, but the present exemplary embodiment is not limited thereto and is applicable to a monochrome image forming apparatus.

### <Image Forming Apparatus>

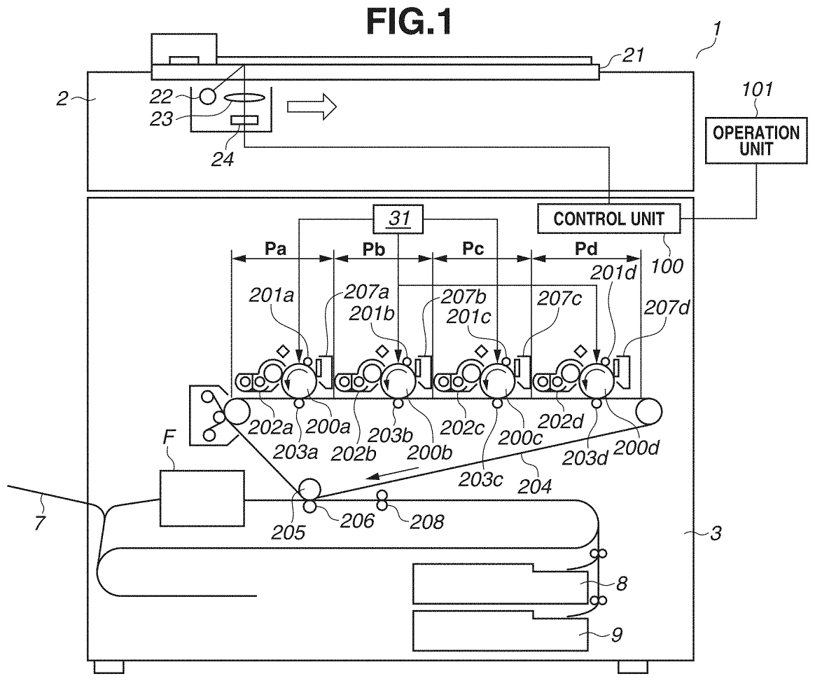

A general configuration of an image forming apparatus 1 according to the present exemplary embodiment will be described with reference to FIG. 1.

FIG. 1 is a diagram illustrating a full-color image forming apparatus according to the present exemplary embodiment. The image forming apparatus 1 includes an image reading unit 2 and an image forming apparatus main body 3. The image reading unit 2 reads an original document placed on a platen glass 21. Light emitted from a light source 22 is reflected by the original document, and forms an image on a charge-coupled device (CCD) sensor 24 via an optical system member 23 such as a lens. Such an optical system unit converts the original document into an electric signal data stream for each line by scanning in a direction indicated by a white arrow in FIG. 1. An image signal obtained by the CCD sensor 24 is sent to the image forming apparatus main body 3, and image processing for each image forming unit to be described below is performed on the image signal by a control unit 100. The control unit 100 also accepts an external input from an external host apparatus, such as a print server, as the image signal.

In the image forming apparatus main body 3, four types of image forming unit, specifically, image forming units Pa of yellow, Pb of magenta, Pc of cyan, and Pd of black, are disposed in a moving direction of an intermediate transfer belt 204. First, processes by which a toner image is formed on the intermediate transfer belt 204 will be described using the image forming unit Pa of yellow as an example.

In FIG. 1, a surface of a photosensitive drum 200a driven to rotate is uniformly charged by a charger 201a (electrostatic charge). Then, an exposure device 31 emits a laser to the surface of the photosensitive drum 200a based on input image data, so that an electrostatic latent image is formed on the surface of the photosensitive drum 200a (exposure). Subsequently, a development device 202a forms a toner image of yellow on the photosensitive drum 200a. A primary transfer roller 203a applies a voltage having a polarity opposite to the polarity of the yellow toner image, to the intermediate transfer belt 204. Yellow toner on the photosensitive drum 200a is thereby transferred to the intermediate transfer belt 204 (primary transfer). The yellow toner remaining on the surface of the photosensitive drum 200a without being transferred is scraped by a toner cleaner 207a, and thereby removed from the surface of the photosensitive drum 200a. The series of processes is similarly performed in the image forming units Pb of magenta, Pc of cyan, and Pd of black. As a result, a full-color toner image is formed on the intermediate transfer belt 204.

The toner image on the intermediate transfer belt 204 is conveyed to a secondary transfer portion formed by a pair of secondary transfer rollers 205 and 206. Printing media are taken out one by one from a printing medium cassette 8 or 9 and fed to the secondary transfer portion, in synchronization with a timing of the transfer of the toner image. Then, the toner image on the intermediate transfer belt 204 is transferred to the printing medium (secondary transfer).

The printing medium to which the toner image is transferred is conveyed to a fixing device F, and the toner image is fixed to the printing medium by receiving heat and pressure in the fixing device F (fixing). The printing medium to which the toner image is fixed is ejected to a sheet discharge tray 7.

The image forming apparatus 1 can also perform monochrome image formation. In the monochrome image formation, only the image forming unit Pd of black among the plurality of image forming units is driven.

In a case where image formation on both sides of the printing medium is performed, after transfer and fixing of toner to an image formation first surface (a first side) are completed, the printing medium is turned upside down at a reversing portion in the image forming apparatus 1. Then, transfer and fixing of toner to an image formation second surface (a second side) are performed, and the printing medium is ejected and placed on the sheet discharge tray 7.

The process from the electrostatic charge to the ejection of the printing medium to which the toner image is fixed to the sheet discharge tray 7 is referred to as an image formation process (a print job). In addition, a period during which the image formation process is performed is referred to as an image formation processing time (a print job in process).

### <Fixing Device>

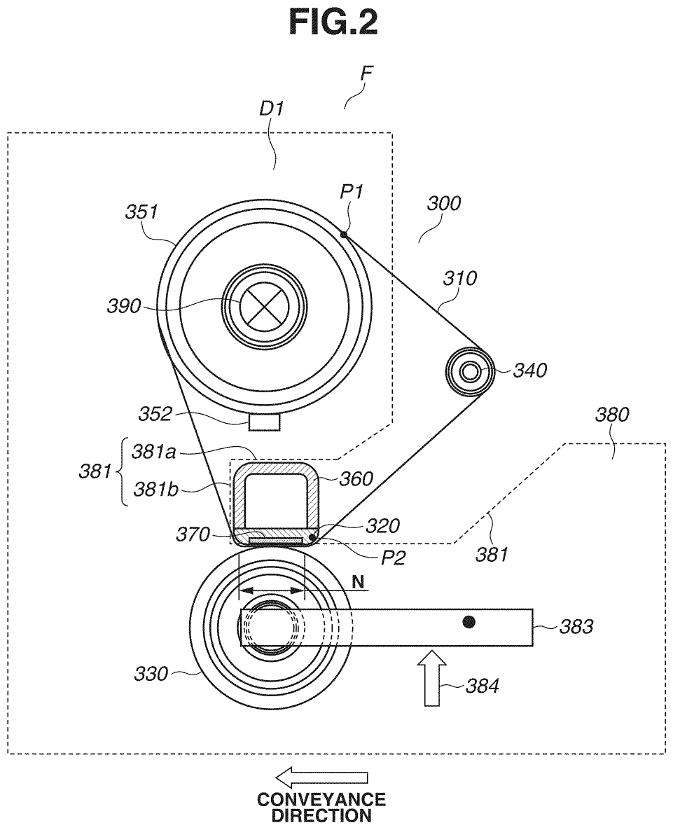

FIG. 2 illustrates a schematic diagram of an overall configuration of the fixing device F of a belt heating type according to the present exemplary embodiment. In FIG. 2, the printing medium is conveyed in a right-to-left direction. The fixing device F includes a fixing belt (hereinafter, belt) 310 serving as an endless rotatable heating rotary member, and a pressing pad (hereinafter, pad) 320, as members that form a nip portion N. The fixing device F further includes a heating unit 300 including a heating roller 351 and a steer roller 340, and a pressing roller 330 serving as a pressing rotary member facing the belt 310 to form the nip portion N with the belt 310.

The belt 310 has heat conductivity and heat resistance, and has a thin cylindrical shape having an inner diameter of 120 mm. In the present exemplary embodiment, the belt 310 has a three-layer structure in which a base layer is formed, an elastic layer is formed on the outer periphery of the base layer, and a release layer is formed on the outer periphery of the elastic layer. The base layer has a thickness of 60 μm, and polyimide resin (PI) is used therefor as a material. The elastic layer has a thickness of 300 μm, and silicone rubber is used therefor as a material. The release layer has a thickness of 30 μm, and tetrafluoroethylene-perfluoroalkoxyethylene copolymer resin (PFA) as fluoroplastic is used therefor as a material. The belt 310 is stretched around the pad 320, the heating roller 351, and the steer roller 340.

Across the belt 310, the pad 320 is pressed against the pressing roller 330. Liquid crystal polymer (LCP) resin is used as a material for the pad 320. A lubrication sheet 370 is interposed between the pad 320 and the belt 310. A PI sheet coated with polytetrafluoroethylene (PTFE) is used as the lubrication sheet 370, and the lubrication sheet 370 has a thickness of 100 μm. Protrusions each having a height of 100 μm are formed at intervals of 1 mm on the PI sheet, so that the area of a portion in contact with the belt 310 is reduced and sliding friction is thereby reduced. A lubricant is applied to the inner surface of the belt 310, so that the belt 310 smoothly slides on the pad 320. Silicone oil having a viscosity of 100 centistoke (cSt) is used as the lubricant.

While the pad 320 is described above as being used as a means of forming the nip portion, a member such as a rotary member represented by a roller may be used.

The heating roller 351 is a hollow roller using stainless steel for a core metal, and a halogen heater 390 is disposed inside the core metal so that the halogen heater 390 can generate heat up to a predetermined temperature. The belt 310 is heated by the heating roller 351 warmed by the halogen heater 390. A temperature control unit 102 controls the temperature of the belt 310 to a predetermined target temperature depending on the paper type, based on temperature detection by a thermistor 352. The thermistor 352 is in contact with the heating roller 351.

The heating roller 351 has a shaft, and a gear is fixed to one end of the shaft. The heating roller 351 is connected to a driving roller driving source and rotated via the gear. The rotation of the heating roller 351 applies a conveyance force to the belt 310. The heating roller 351 may be rotated by a driving force applied from a pressing roller driving source for rotating the pressing roller 330, or may be rotated by a driving force applied by the driving roller driving source, which is a driving source different from the pressing roller driving source. In other words, the driving source for rotating the heating roller 351 may be any means.

The pressing roller 330 is a roller having an elastic layer formed on the outer periphery thereof and a release layer formed on the outer periphery of the elastic layer. Stainless steel is used for a core metal. The elastic layer has a thickness of 5 mm, and conductive silicone rubber is used therefor. The release layer has a thickness of 50 μm, and PFA as fluoroplastic is used therefor. The pressing roller 330 is rotatably supported by a fixing frame 380 of the fixing device F. A gear is fixed to one end of the pressing roller 330, and the pressing roller 330 is connected to the pressing roller driving source and driven and rotated via the gear. A rotational driving means for driving and rotating the pressing roller 330 may be any means, as with the heating roller 351.

The belt 310 and the pressing roller 330 described above form the nip portion N.

At the nip portion N, heat and pressure required for fixing are applied to the toner image, while the printing medium carrying the toner image is nipped and conveyed. In this way, the fixing device F fixes the toner image to the printing medium while nipping and conveying the printing medium.

The fixing frame 380 includes a heating unit positioning portion 381, a pressing frame 383, and a pressing spring 384. A stay 360 of the heating unit 300 is inserted into the heating unit positioning portion 381, and fixed to the heating unit positioning portion 381 by a fixing means (not illustrated).

After the stay 360 is fixed, the pressing frame 383 is moved by a driving source and a cam (not illustrated), so that the pressing roller 330 is pressed against the pad 320 via the belt 310.

Here, at the heating unit positioning portion 381, a pressing direction regulating surface 381a is opposite the pressing roller 330, and a conveyance direction regulating surface 381b is a contact surface of the heating unit 300 in an insertion direction.

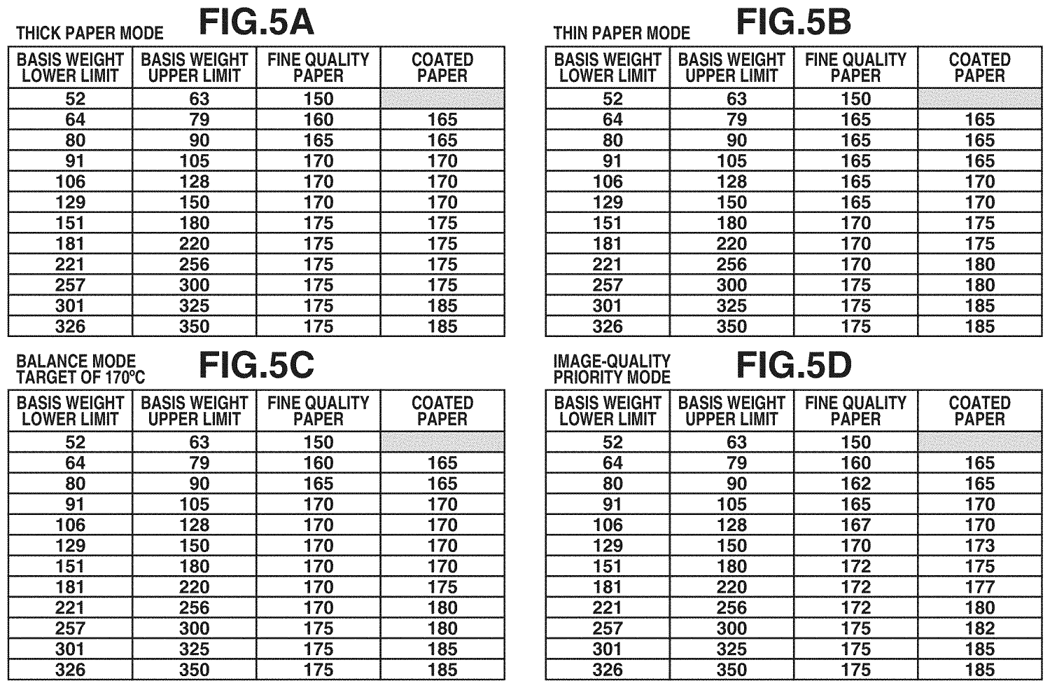

A print speed is 630 mm/s, a pressing force at the nip portion N is 1000 N, and the target temperature of the belt 310 when the toner image is fixed to the printing medium is as illustrated in FIGS. 5A, 5B, 5C, and 5D.

As a means of maintaining the conveyance posture of the belt 310, the steer roller 340 is located upstream from the nip portion N. The steer roller 340 is urged by a spring supported by a frame of the heating unit 300. The steer roller 340 is a tension roller that applies a predetermined tensile force to the belt 310, and rotates by following the belt 310. The tension by the spring is 50 N, and the tension is applied to the belt 310 from the inner side.

The steer roller 340 has the rotation center at an end or near the center in the longitudinal direction, and generates a tension difference between back and forth by being rotated with respect to the belt 310, thereby controlling the position of the belt 310 in the main scanning direction. The configuration according to the present exemplary embodiment is a configuration having the rotation center at the center in the longitudinal direction, but a configuration having the rotation center at one end in the longitudinal direction may be used. The steer roller 340 is urged by the spring supported by the frame of the heating unit 300, and the steer roller 340 is the tension roller that applies the predetermined tensile force to the belt 310. The tensile force by the spring is 50 N, and the belt position in the main scanning direction is controlled by applying the tension to the belt 310.

The steer roller 340 is intended to stabilize the behavior of the belt 310 entering the nip portion N. The steer roller 340 is a hollow pipe made of stainless steel (SUS) and having a thickness of 1 mm, and rotates by following the belt 310.

As to surface roughness, a relatively smooth state with arithmetic average roughness Ra=0.05 [μm] is used. However, as long as the driving torque or internal scraping of the belt 310 is not an issue, the surface roughness of the steer roller 340 does not matter, and the surface may be formed of, for example, rubber.

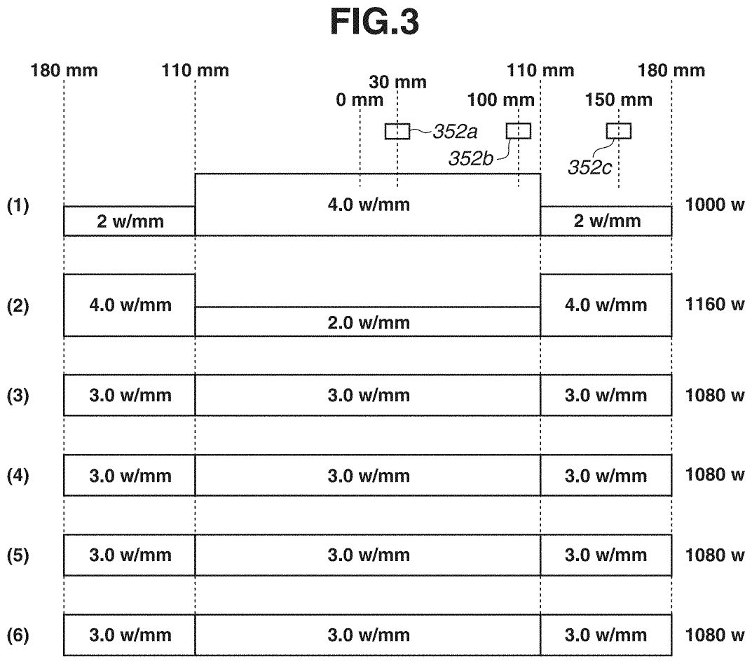

A configuration of each of the halogen heater 390 and the thermistor 352 according to the present exemplary embodiment will be described with reference to FIG. 3.

In the present exemplary embodiment, six halogen heaters 390 are used. FIG. 3 illustrates a heat distribution of each of the six halogen heaters 390. In the widthwise direction of the belt 310, an amount of heat at a central portion is greater than at end portions in a heater (1) illustrated in FIG. 3. In a heater (2), an amount of heat at end portions in the widthwise direction of the belt 310 is greater than at a central portion. This is to make the heat distribution uniform at the center and the end portions in the widthwise direction of the belt 310. The thermistors 352 are respectively disposed at positions of 3 mm, 100 mm, and 150 mm away from the center position of the heating roller 351 in the widthwise direction of the belt 310, and constantly measure the temperature of the heating roller 351. Using the temperature, the temperature of the belt 310 is predicted based on the relative relationship between the heating roller 351 and the belt 310, and the temperature for fixing is thereby controlled.

In the present exemplary embodiment, the configuration illustrated FIG. 3 is used, but the present exemplary embodiment is not limited thereto.

The number of the halogen heaters 390, the number of the thermistors 352, the positional relationship between the halogen heater 390 and the thermistor 352, and the heat distribution of the halogen heater 390 may be changed. Further, the thermistor 352 may be in contact with the belt 310 to measure the temperature, so that the temperature of the belt 310 can be directly observed.

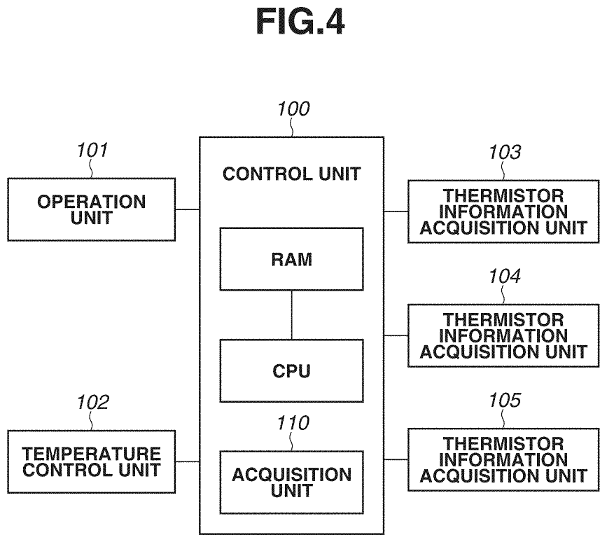

FIG. 4 illustrates a block diagram according to the present exemplary embodiment. FIG. 4 illustrates a control system of the image forming apparatus 1 including the fixing device F according to the present exemplary embodiment. The control unit 100 controls the entire image forming apparatus 1, and an operation unit 101 including a liquid crystal touch panel and a button is connected to the control unit 100. The image forming apparatus 1 starts operating based on input of various conditions by a user via the operation unit 101.

Information such as the size and basis weight of a printing medium (sheet) to be fed is transmitted from the operation unit 101 or the like to an acquisition unit 110. When printing is started, the acquisition unit 110 acquires print information beforehand, and paper type information for 15 sheets from a print start is saved into the acquisition unit 110. In the present exemplary embodiment, the paper type information for 15 sheets is acquired, but the present exemplary embodiment is not limited to this number of sheets.

Further, thermistor information acquisition units 103, 104, and 105 are provided for thermistors 352a, 352b, and 352c, respectively. The thermistor information acquisition units 103, 104, and 105 transmit information indicating the temperature of the central portion in the longitudinal direction of the heating roller 351, information indicating the temperature between the central portion and the end portion, and information indicating the temperature of the end portion, respectively, to the control unit 100.

The image forming apparatus 1 according to the present exemplary embodiment has a productivity priority mode giving priority to productivity, and an image-quality priority mode (a second mode) giving priority to image quality, and can perform fixing of a toner image using these modes. Further, the productivity priority mode includes a plurality of types of mode, and fixing of the toner image can be performed in any of the plurality of types of mode. For example, the image forming apparatus 1 according to the present exemplary embodiment has a thick paper mode (a third mode) giving priority to productivity of thick paper printing, a thin paper mode (a fourth mode) giving priority to productivity of thin paper printing, and a balance mode giving priority to productivity of printing of paper having a basis weight between the thin paper and the thick paper. In this way, the productivity of printing can be increased by provision of the plurality of types of mode depending on the basis weight of the printing medium for printing. Thus, in a case where fixing is performed in the thin paper mode for a job in which a printing medium of 64 g/m² and a printing medium of 91 g/m² that are defined as the thin paper are mixed, the fixing is performed at the same temperature. However, in the case of the thick paper mode, it is necessary to change the temperature of the belt 310 from 160° C. to 170° C. Thus, for the job in which the printing medium of 64 g/m² and the printing medium of 91 g/m² are mixed, the productivity is higher when fixing is performed in the thin paper mode than when fixing is performed in the thick paper mode. In other words, in the case of a job in which printing media each having a basis weight less than or equal to a predetermined basis weight are mixed, the productivity is higher when fixing is performed in the thin paper mode than when fixing is performed in the thick paper mode. Similarly, in a case where fixing is performed in the thick paper mode for a job in which a printing medium of 221 g/m² and a printing medium of 257 g/m² that are defined as the thick paper are mixed, the fixing is performed at the same temperature. However, in the case of the thin paper mode, it is necessary to change the temperature of the belt 310 from 170° C. to 175° C. Since it is necessary to change the temperature of the belt 310, image formation can be interrupted. Thus, for the job in which the printing medium of 221 g/m² and the printing medium of 257 g/m² are mixed, the productivity tends to be higher when fixing is performed in the thick paper mode than when fixing is performed in the thin paper mode. In other words, in a case where printing media each having a basis weight more than or equal to a predetermined basis weight are mixed, the productivity tends to be higher when fixing is performed in the thick paper mode than when fixing is performed in the thin paper mode.

The productivity herein refers to the number of sheets printed in unit time. The productivity is high if the number of sheets printed in unit time is large, and the productivity is low if the number of sheets printed in unit time is small. The productivity changes depending on a speed at which a printing medium is conveyed, a change in distance between printing media, or the presence or absence of downtime.

Specifically, as an example, paper of 52 to 105 g/m² is defined as thin paper, paper of 106 to 220 g/m² is defined as plain paper, and paper of 221 to 350 g/m² is defined as thick paper. In the present exemplary embodiment, the same temperature is used for a printing medium in the range of thin paper in the thin paper mode. Similarly, the same temperature is used for a printing medium in the range of thick paper in the thick paper mode, and the same temperature is used for a printing medium in the range of plain paper in the balance mode. The range in which fixing can be performed using the same temperature is changed depending on the mode. The productivity can be thereby improved depending on the basis weight.

The fixing device F also has the image-quality priority mode. The image-quality priority mode is a mode in which priority is given to the quality of an image to be formed. Thus, the temperature is changed based on the basis weight more finely than in the modes included in the productivity priority mode. The quality of a toner image formed on a printing medium depends on the amount of heat applied to the toner image. There is an optimum temperature depending on the basis weight of the printing medium, and the image quality can be improved by giving the optimum temperature. In the image-quality priority mode, temperatures are finely set depending on the basis weight and the type (coated paper or non-coated paper) of the printing medium. Thus, in a case where printing is performed in the image-quality priority mode for a mixed job in which the printing media of different basis weights are mixed, the temperature of the belt 310 is more frequently changed than in the productivity priority mode. In a case where the temperature of the belt 310 is to be changed, it is necessary to provide time to change the temperature, and thus the productivity tends to be lower. Thus, when a comparison is made between a case where printing is performed in the image-quality priority mode and a case where printing is performed in the productivity priority mode for the mixed job, the image quality tends to be higher in the case where printing is performed in the image-quality priority mode than in the case where printing is performed in the productivity priority mode. Meanwhile, the productivity tends to be lower in the case where printing is performed in the image-quality priority mode than in the case where printing is performed in the productivity priority mode.

If fixing is performed for printing media of various basis weights using the same temperature, it is not necessary to provide the plurality of types of productivity priority mode. However, in a case where fixing is performed for the printing media of various basis weights using the same temperature, heat can be insufficiently or excessively applied. Thus, in the present exemplary embodiment, the plurality of types of productivity priority mode is provided. In the present exemplary embodiment, the configuration having the three productivity priority modes is used, but the present exemplary embodiment is not limited thereto. There are a case where a mode is selected based on automatic determination using paper type information about 15 sheets based on a content of the acquisition unit 110 in the image forming apparatus 1 (a first mode), and a case where a user manually sets a mode in a user mode. Temperature tables for the respective modes, i.e., the thick paper mode, the thin paper mode, the balance mode, and the image-quality priority mode, are illustrated in FIGS. 5A, 5B, 5C, and 5D.

FIGS. 5A, 5B, 5C, and 5D illustrate the temperature table for the thick paper mode, the temperature table for the thin paper mode, the temperature table for the balance mode, and the temperature table for the image-quality priority mode, respectively. In each of the temperature tables, a temperature is set based on the basis weight of the printing medium. In the fixing device F having the plurality of modes, the temperature of the heating rotary member is changed depending on the basis weight of the printing medium for which fixing is to be performed.

However, in a mixed job in which printing media varying in basis weight are mixed, it is necessary to change the temperature of the belt 310 each time the basis weight of the printing medium changes. The issue of changing the temperature can be addressed by increasing the range for performing fixing using the same temperature, as in the productivity priority modes illustrated in FIGS. 5A, 5B, and 5C. However, in a case where the basis weights of the printing media greatly vary in the same job, it is necessary to change the temperature of the belt 310. The larger an amount of temperature change of the belt 310 is, the longer the temperature changing time is. If the temperature changing time is long, image formation is interrupted accordingly, and thus downtime occurs.

Therefore, the fixing device F according to the present exemplary embodiment is directed to preventing a reduction in productivity in a case where fixing is performed for a job in which printing media varying in basis weight are mixed.

### <First Detailed Verification>

The productivity priority mode according to the present exemplary embodiment has the first mode, and the first mode is a mode of automatically determining which one of the plurality of modes included in the productivity priority mode is to be applied. The first mode will be described in detail below.

The image forming apparatus 1 or the fixing device F according to the present exemplary embodiment includes the acquisition unit 110 that acquires information about a printing medium before starting image formation. The acquisition unit 110 acquires information about the basis weight for a predetermined number of sheets (in the present exemplary embodiment, 15 sheets) of printing medium. Not only the information about the basis weight, but also, for example, information about the paper type may be acquired.

A case where fixing in the first mode is selected will be described. The productivity priority mode according to the present exemplary embodiment includes the thick paper mode, the thin paper mode, and the balance mode. Thus, the temperature control unit 102 selects one of fixing in the thick paper mode, fixing in the thin paper mode, and fixing in the balance mode, based on the information acquired by the acquisition unit 110. In the process, a mode corresponding to the smallest amount of temperature change is selected.

This will be described using an example. Among 15 sheets for which the acquisition unit 110 has acquired information about the printing medium beforehand, printing was performed on first 5 sheets of fine quality paper of 100 g/m² (Mondi 100), and subsequent 10 sheets of coated paper of 300 g/m² (UPM Finesse gloss 300).

A case where the above-described example of printing is performed in the first mode and a case where the above-described example is performed in the thin paper mode will be described. The paper of 52 to 105 g/m² is defined as the thin paper, the paper of 106 to 220 g/m² is defined as the plain paper, and the paper of 221 to 350 g/m² is defined as the thick paper. Because printing is performed on the thin paper in the example, it is necessary for a user to manually select a mode, and thus the thin paper mode is selected. Thus, a case where fixing is performed in the thin paper mode will be described as a comparative example. Referring to the temperatures in the temperature table in FIG. 5C, printing begins at a temperature of 165° C. for the fine quality paper of 100 g/m², and the temperature is switched to a temperature of 180° C. for the coated paper of 300 g/m². In the fixing configuration, in a case where a temperature difference is greater than 5° C., it is necessary to interrupt printing once and to adjust the temperature of the fixing device F to a temperature after switching. Thus, a waiting time before the temperature is adjusted occurs.

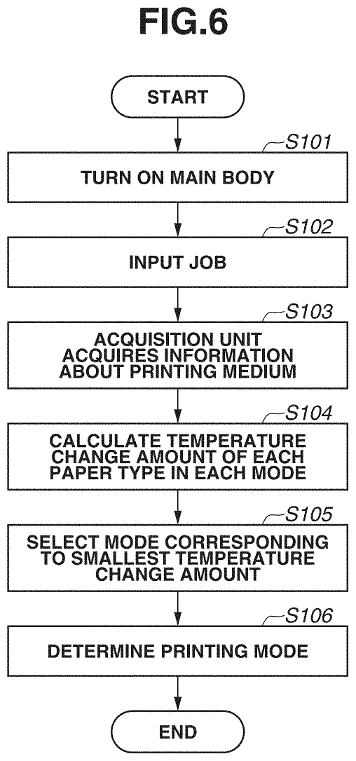

In the first mode of the present exemplary embodiment, a mode is selected through steps of a flowchart in FIG. 6. At the start, in step S101, the main body is turned on. In step S102, a user inputs a job. In step S103, the acquisition unit 110 acquires information about the basis weight of a printing medium. In this step, other than the basis weight, a paper type (a basis weight, a surface property, and a shape) of a print content is acquired. In the present exemplary embodiment, the basis weight information is used. Here, printing is performed using first 5 sheets of fine quality paper of 100 g/m² (Mondi 100), and subsequent 10 sheets of coated paper of 300 g/m² (UPM Finesse gloss 300), and thus, the description will be provided using this example. Then, in step S104, a temperature change amount of each paper type is calculated in each mode. The following table indicates the result of the calculation.

TABLE 1
Case of 91 to 105 g (Fine Quality Paper) to
257 to 300 g (Coated Paper)

| | | | Temperature |
|---|---|---|---|
| | 91-105 g | 257-300 g | Δ (° C.) |
| The thin paper mode | 165 | 180 | 15 |
| The balance mode | 170 | 180 | 10 |
| The thick paper mode | 170 | 175 | 5 |

In the case of the thin paper mode, the change amount of temperature is 15° C. In the case of the balance mode, the change amount of temperature is 10° C. In the case of the thick paper mode, the change amount of temperature is 5° C. Thus, in step S105, the thick paper mode corresponding to the smallest temperature change amount is automatically selected. In step S106, the mode for printing is determined.

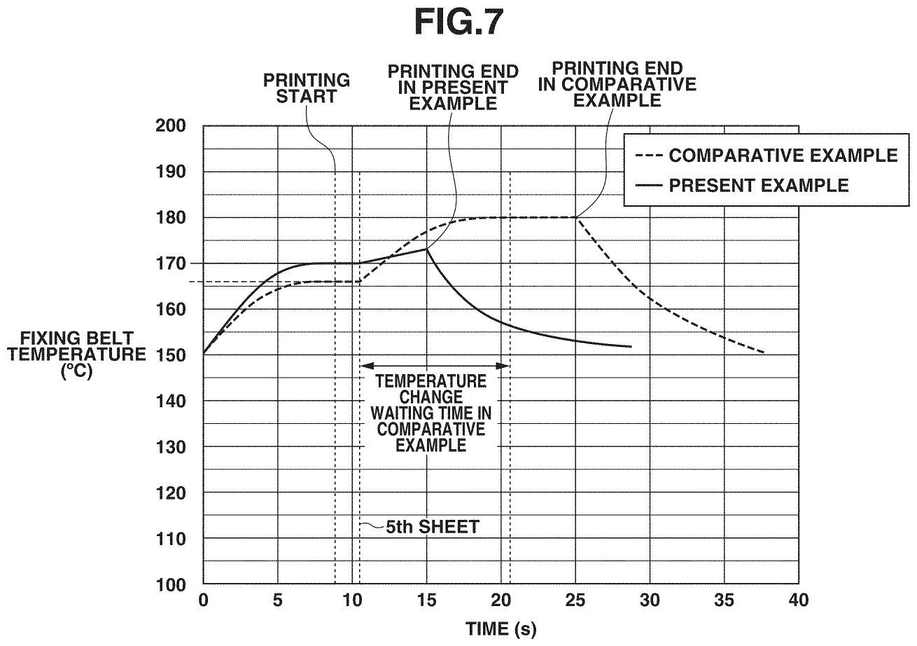

FIG. 7 illustrates a result of making a comparison with the comparative example. In the comparative example (a broken line), sheets are supplied in the thin paper mode. In the first mode, sheets are supplied in the thick paper mode. A temperature changing time of 10 seconds has occurred in the comparative example. Meanwhile, by the first mode (a solid line), sheets are supplied in the thick paper mode, so that printing is completed without downtime. As a result, it is possible to prevent a decrease in the number of print sheets per unit time in a job in which printing media varying in basis weight are mixed.

Using a similar verification method, a comparison is made between a case where fixing is performed in the first mode and a case where fixing is performed in the image-quality priority mode. A first basis weight is 300 g/m², and a basis weight of 100 g/m², which is less than the first basis weight, is a second basis weight. The size relationship between the first basis weight and the second basis weight is not limited thereto, and other basis weights may be used as long as the basis weights are different. In a case where fixing is performed in the first mode, the thick paper mode is used.

Thus, in a case where fixing is performed for the printing medium of the first basis weight, the temperature of the belt 310 is controlled to a target of 175° C. (a first temperature). The first temperature is a target temperature in the case of the non-coated paper.

The printing medium of the first basis weight is, in this case, the coated paper. In the case of the coated paper as well, the temperature of the belt 310 is controlled to a target of 175° C. (a fifth temperature). In a case where fixing is performed for the printing medium of the second basis weight, the temperature of the belt 310 is controlled to a target of 170° C. (a second temperature). In a case where fixing is performed in the image-quality priority mode, concerning the first basis weight, the temperature is 182° C. (a sixth temperature) in the case of the coated paper, and 175° C. (a third temperature) in the case of the non-coated paper. Further, in a case where fixing is performed for the printing medium of the second basis weight, the temperature of the belt 310 is controlled to a target of 165° C. (a fourth temperature). The difference between the first temperature and the second temperature is 5° C., and the difference between the third temperature and the fourth temperature is 10° C. Therefore, in a case where fixing is performed in the first mode for a mixed job in which the printing medium of the second basis weight and the printing medium of the first basis weight are mixed, the temperature difference is smaller than in a case where fixing is performed in the image-quality priority mode. This reduces the time to adjust the temperature of the belt 310, so that the productivity can be improved.

In the case where fixing is performed in the image-quality priority mode, the fixing is performed at 182° C. in the case of the first basis weight and the coated paper. If the sixth temperature is 182° C., the difference between the second temperature and the fifth temperature is 5° C., and the difference between the sixth temperature and the fourth temperature is 17° C. Even for a job in which the coated paper and the non-coated paper are mixed, the time to adjust the temperature of the belt 310 is reduced, so that the productivity can be improved.

In the present exemplary embodiment, the example in which the first temperature and the fifth temperature are identical is described, but the present exemplary embodiment is not limited thereto, and these temperatures may be different.

### <Second Detailed Verification>

Verification was performed using a use case different from the first detailed verification. Specifically, while two types of printing medium are mixed in the job in the first detailed verification, three types of printing medium are mixed in a job in a second detailed verification.

As an example, the coated paper of 128 g/m² (OK top coat 128) is used for 1st to 4th sheets. The fine quality paper of 68 g/m² (CS-068) is used for 5th to 8th sheets. The fine quality paper of 209 g/m² (GF-C209) is used for 9th to 12th sheets. The coated paper of 350 g/m² (UPM Finesse gloss 350) is used for 13th to 15th sheets. Printing was performed using these types of paper. When the first mode of the present exemplary embodiment is selected, a mode is selected through the steps of the flowchart in FIG. 6 with reference to the temperature tables in FIGS. 5A, 5B, 5C, and 5D.

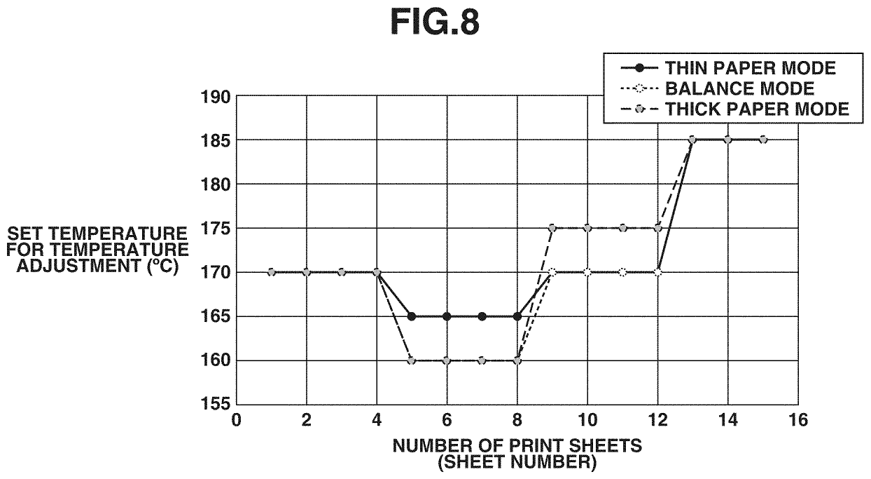

At the start, in step S101, the main body is turned on. In step S102, a user inputs a job. In step S103, the acquisition unit 110 acquires information about the printing medium. The description will be provided using the example of the printing media used in the second detailed verification. Then, in step S104, a temperature change amount of each paper type is calculated in each mode. The following table indicates the result of the calculation. Transition of the set fixing temperature for each mode is illustrated in FIG. 8.

TABLE 2

| | Coated | Fine Quality | Fine Quality | Coated | |
|---|---|---|---|---|---|
| | Paper | Paper | Paper | Paper | Tem- |
| | 106 to 128 | 64 to 79 | 181-220 | 326-350 | perature |
| | g/m² | g/m² | g/m² | g/m² | Δ |
| The thin | 170 | 165 | 170 | 185 | 25 |
| paper mode | | | | | |
| The balance | 170 | 160 | 170 | 185 | 35 |
| paper mode | | | | | |
| The thick | 170 | 160 | 175 | 185 | 35 |
| paper mode | | | | | |

In the case of the thin paper mode, the temperature difference is 25° C. As a breakdown, when the paper is switched from the coated paper of 106 to 128 g/m² to the fine quality paper of 64 to 79 g/m², the temperature is changed by 5° C. When the paper is switched from the fine quality paper of 64 to 79 g/m² to the fine quality paper of 181 to 220 g/m², the temperature is changed by 5° C. When the paper is switched from the fine quality paper of 181 to 220 g/m² to the coated paper of 326 to 350 g/m², the temperature is changed by 15° C. Therefore, the temperature is changed by 25° C. in total.

In the case of the balance mode, the temperature change amount is 35° C. As a breakdown, when the paper is switched from the coated paper of 106 to 128 g/m² to the fine quality paper of 64 to 79 g/m², the temperature is changed by 10° C. When the paper is switched from the fine quality paper of 64 to 79 g/m² to the fine quality paper of 181 to 220 g/m², the temperature is changed by 10° C. When the paper is switched from the fine quality paper of 181 to 220 g/m² to the coated paper of 326 to 350 g/m², the temperature is changed by 15° C. Therefore, the temperature is changed by 35° C. in total.

In the case of the thick paper mode, the temperature difference is 35° C. As a breakdown, when the paper is switched from the coated paper of 106 to 128 g/m² to the fine quality paper of 64 to 79 g/m², the temperature is changed by 10° C. When the paper is switched from the fine quality paper of 64 to 79 g/m² to the fine quality paper of 181 to 220 g/m², the temperature is changed by 15° C. When the paper is switched from the fine quality paper of 181 to 220 g/m² to the coated paper of 326 to 350 g/m², the temperature is changed by 10° C. Therefore, the temperature is changed by 35° C. in total.

In step S105, from the above-described result, the thin paper mode corresponding to the smallest difference is automatically selected. In step S106, the mode for printing is determined.

In the case where the thin paper mode is selected in the verification, the temperature change amount is 25° C., but when the printing medium is switched from the coated paper of 128 g/m² to the fine quality paper of 68 g/m², the temperature is changed from 170° C. to 165° C., and thus the difference is only 5° C. Further, when the printing medium is switched from the fine quality paper of 68 g/m² to the fine quality paper of 209 g/m², the temperature is changed from 165° C. to 170° C., and thus the difference is also only 5° C. The temperature change transitions from 170° C. to 165° C. and from 165° C. to 170° C. Therefore, it is also possible to supply sheets after automatically and uniformly correcting the temperature to 170° C. and setting the corrected temperature at the time of printing.

### <Third Detailed Verification>

Verification was performed using a use case different from the first and second detailed verifications. In a third detailed verification, there will be described a case where the number of sheets of printing medium exceeding the number of sheets of printing medium that can be acquired by the acquisition unit 110 at a time is supplied for printing.

A case where printing is performed using the printing media of different basis weights in a case where the first mode is selected was verified.

In the verification, the number of sheets to be supplied is increased. The acquisition unit 110 can acquire information about printing media of up to 15 sheets, and thus in this verification, printing was performed for 20 sheets (a mode for printing more than 15 sheets was verified).

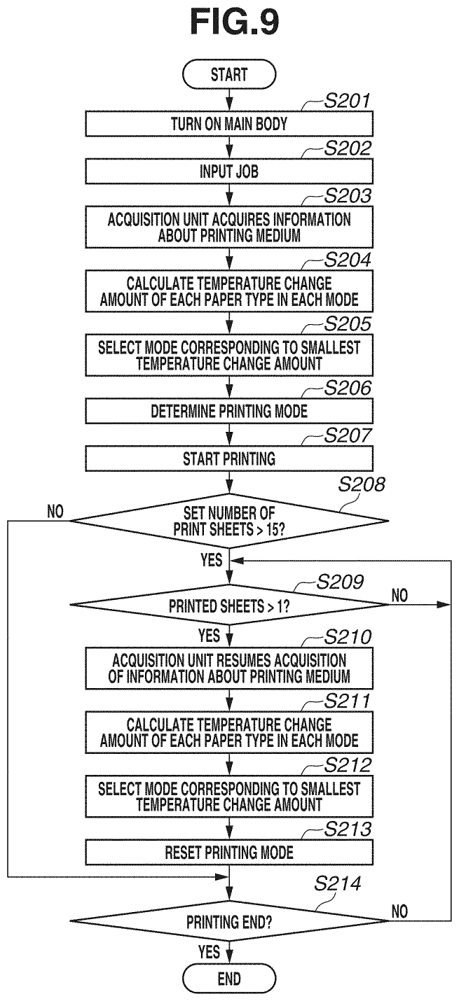

As an example, printing was performed for 1st to 15th sheets of the thin fine quality paper of 105 g/m² (GF-C104), and 16th to 20th sheets of the coated paper of 300 g/m² (UPM Finesse gloss 300). In the first mode of the present exemplary embodiment, a temperature table (a mode) is selected through steps of a flowchart in FIG. 9 with reference to the temperature tables in FIGS. 5A, 5B, 5C, and 5D.

At the start, in step S201, the main body is turned on. In step S202, a user inputs a job. In step S203, the acquisition unit 110 acquires information about the printing medium. In the verification, printing was performed for the 1st to 15th sheets of the thin fine quality paper of 105 g/m² (GF-C104), and the 16th to 20th sheets of the coated paper of 300 g/m² (UPM Finesse gloss 300), and thus, the description will be provided using the example. Then, in step S204, a temperature change amount of each paper type is calculated in each mode. As a result of the calculation, since all of the 1st to 15th sheets are the thin fine quality paper of 105 g/m² (GF-C104), the temperature change amount is 0 in the case of the thin paper mode. Thus, in step S205, the thin paper mode is selected as a mode at the time of start. In step S206, the mode for printing is determined. In step S207, printing starts. In step S208, whether the set number of print sheets is larger than 15 is determined. In a case where the set number of print sheets is larger than 15 (YES in step S208), then in step S209, whether the number of printed sheets has exceeded 1 is determined. In a case where the number of printed sheets has exceeded 1 (YES in step S209), then in step S210, the acquisition unit 110 resumes acquisition of information about the printing medium. Therefore, the sheet information for 15 sheets, e.g., 2nd to 16th sheets, and then 3th to 17th sheets, etc., is always acquired beforehand, and, in step S211, the temperature change amount is calculated again.

As a result, in step S212, a mode corresponding to the smallest temperature change amount among the change amounts calculated for the respective tables is selected. This time, the thick paper mode is selected. In step S213, based on the selection result, the printing mode is reset. In step S214, step S209 to step 213 are repeated until the printing ends.

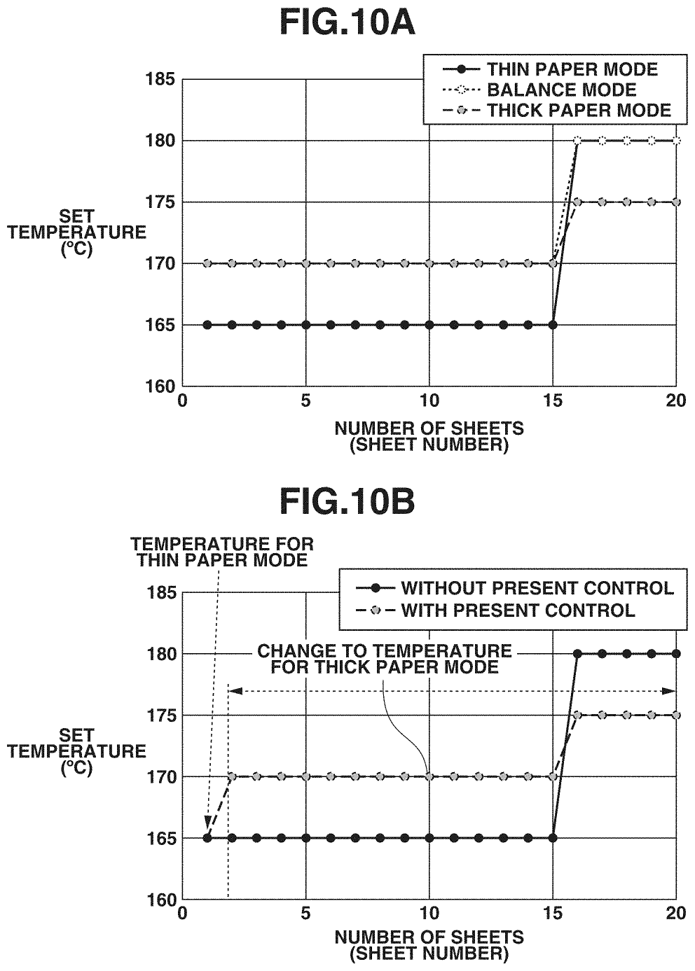

As a result, in a case where printing is performed in the thin paper mode as a comparative example, the table of the thin paper is used for the 1st to 15th sheets, and the temperature is changed for the 16th and subsequent sheets, as illustrated in FIG. 10A. Thus, downtime of 10 seconds occurs when the temperature changes. In a case where the first mode is selected and printing is performed, the thin paper mode is used for the first sheet, but the temperature can be changed based on the information acquired by the acquisition unit 110 for the second and subsequent sheets, as illustrated in FIG. 10B. Then, the temperature is changed to the temperature of the thick paper mode. This can prevent the occurrence of downtime caused by the temperature change.

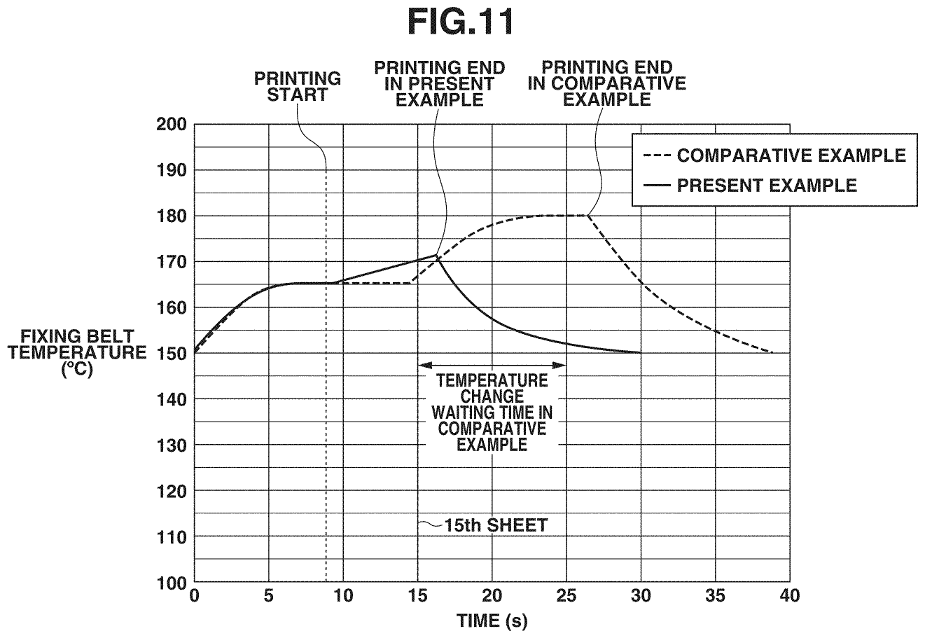

As a result, as illustrated in FIG. 11, in the case of the first mode, the temperature difference is 5° C., and thus there is no waiting time for switching, and printing for the 1st to 20th sheets can be completed without downtime.

The image forming apparatus 1 according to the present exemplary embodiment has predetermined temperature tables depending on the basis weight and the paper type (e.g., the coated paper or the non-coated paper) of printing medium, as illustrated in FIGS. 5A, 5B, 5C, and 5D. In the first mode of the present exemplary embodiment, a table corresponding to a small temperature change amount is selected from the predetermined temperature tables, and the selected table is used for fixing. However, the present exemplary embodiment is not limited thereto. There may be adopted a method of controlling the temperature of the belt 310 by causing the control unit 100 to perform calculation to decrease the temperature change amount based on information about the printing medium acquired by the acquisition unit 110, and determining an optimum temperature as a result of the calculation. In other words, this is a method in which the temperature control unit 102 calculates the temperature based on the information acquired by the acquisition unit 110, instead of selecting a temperature table. This can reduce the temperature change amount, and can thereby improve the productivity in a mixed job.

A user can select a mode to be used for fixing. First, the productivity priority mode or the image-quality priority mode is selected, and a toner image is fixed at the temperature of the image-quality priority mode in a case where the image-quality priority mode is selected. On the other hand, in a case where the productivity priority mode is selected, one mode is selected from the plurality of modes included in the productivity priority mode, i.e., the first mode, the thick paper mode, the thin paper mode, and the balance mode in the present exemplary embodiment, and fixing is performed in the selected mode. The user can thereby select an optimum mode depending on the printing medium to be used for printing.

As described above, in the present exemplary embodiment, fixing for the printing medium can be performed based on the first mode.

In the first mode, the temperature of the belt 310 is controlled based on the information (the basis weight and the paper type) about the printing medium acquired by the acquisition unit 110 before fixing is performed on the printing medium. In a case where the temperature of the belt 310 is controlled in a mixed job, the temperature control unit 102 controls the temperature of the belt 310 to decrease the temperature change amount in the job. This can reduce interruptions of the image formation which accompany the temperature changes. As a result, a reduction in productivity caused by the temperature change in the mixed job can be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-006620, filed Jan. 19, 2022, which is hereby incorporated by reference herein in its entirety.

What is claimed is:

1. An image forming apparatus comprising:
a heating rotary member configured to apply heat to a printing medium;
a pressing rotary member configured to press the heating rotary member;
an acquisition means configured to acquire information about a basis weight of a printing medium for which fixing is to be performed; and
a temperature control means configured to control a fixing temperature based on the information acquired by the acquisition means,
wherein the heating rotary member and the pressing rotary member apply heat and pressure to a printing medium to fix a toner image on the printing medium,
wherein, for a mixed job in which a printing medium of a first basis weight is a first sheet and a printing medium of a second basis weight different from the first basis weight is a second sheet, one mode among a plurality of modes including a first mode and a second mode is executable in the mixed job,
wherein, in a case where the mixed job is performed in the first mode, the temperature control means controls the fixing temperature for the printing medium of the first basis weight based on the information about the printing medium of the first basis weight and the printing medium of the second basis weight, and
wherein, in a case where fixing is performed for the mixed job in the second mode, the temperature control means controls the fixing temperature for the printing medium of the first basis weight based on the information about the printing medium of the first basis weight.

2. The image forming apparatus according to claim 1,
wherein, in a case where fixing is performed for the mixed job in the first mode, the temperature control means uses a first temperature as the fixing temperature for the printing medium of the first basis weight and a second temperature as a fixing temperature for the printing medium of the second basis weight,
wherein, in a case where fixing is performed for the mixed job in the second mode, the temperature control means uses a third temperature as the fixing temperature for the printing medium of the first basis weight and a fourth temperature as the fixing temperature for the printing medium of the second basis weight, and
wherein a difference between the first temperature and the second temperature is smaller than a difference between the third temperature and the fourth temperature.

3. The image forming apparatus according to claim 2, wherein the second temperature and the first temperature are identical.

4. The image forming apparatus according to claim 2,
wherein one mode among a plurality of modes including a third mode and a fourth mode is executable in the mixed job, and
wherein a number of print sheets per unit time of a job in which a printing medium of a basis weight more than or equal to a predetermined basis weight is mixed is larger in the third mode than in the fourth mode, and a number of print sheets per unit time of a job in which a printing medium of a basis weight less than or equal to a predetermined basis weight is mixed is larger in the fourth mode than in the third mode.

5. The image forming apparatus according to claim 1, wherein the first mode has a plurality of temperature tables, and a table corresponding to a smallest temperature change amount is selected from the plurality of temperature tables.

6. An image forming apparatus comprising:
a heating rotary member configured to apply heat to a printing medium;
a pressing rotary member configured to press the heating rotary member;
a temperature control means configured to control a fixing temperature,
wherein the heating rotary member and the pressing rotary member apply heat and pressure to a printing medium to fix a toner image on the printing medium,
wherein, in a first job, a printing medium of a first basis weight is a first sheet, and a printing medium of a second basis weight different from the first basis weight is a second sheet,
wherein, in a second job, the printing medium of the first basis weight is a first sheet, and a printing medium of a third basis weight different from the first basis weight and the second basis weight is a second sheet, and
wherein a fixing temperature for the printing medium of the first basis weight is different between a case where the first job is executed and a case where the second job is executed.
